(19) United States
(12) Patent Application Publication
(10) Pub. No.: US 2008/0065459 A1
(43) Pub. Date: Mar. 13, 2008

(54) METHOD AND APPARATUS FACILITATING GOAL BASED INTELLIGENT CALENDAR MANAGEMENT USING POLICIES AND DATA ANALYSIS

(75) Inventors: Louis J. Lundell, Buffalo Grove, IL (US); Yan M. Cheng, Inverness, IL (US); Thomas J. Mactavish, Inverness, IL (US); Alfred N. Danial, Lake Zurich, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/531,449

(22) Filed: Sep. 13, 2006

(51) Int. Cl. G06F 9/46

(52) U.S. Cl. 705/9

(57) ABSTRACT

A method (100) or system (600) of facilitating goal based calendar management can include creating a calendar item (106) from a user entry (102) and an external entry (104), determining (108) if the calendar item is a policy related item, extracting policy attributes (110) for the calendar item, determining (112) if an action is required based on the policy attributes, the user entry, and the external entry, and executing the action based on the policy attributes. The method can further include presenting (114) a suggested action based on the policy attributes and accepting an entry (116) corresponding to the suggested action. The method can further present a modification of the external entry based on the policy attributes and accept an entry corresponding to the modification of the external entry. The method can also present an action related to a common context as a result of an analysis of the attributes.

### FIELD

This invention relates generally to digitally-modifiable calendars, and more particularly to a method and system of using user goals or policy statements and contextual information to facilitate intelligent calendaring.

### BACKGROUND

Digitally-based modifiable calendars are frequently found and maintained on (or accessible via) a variety of digital processing platforms such as one-way and two-way communications devices, personal digital assistants, and personal computers. These calendars typically present ordinary calendar data such as information regarding years, months, weeks, days and dates, and holidays and users are required to populate the calendars by manual text input based on their plans for the calendar period under consideration. The text input is based both on pull down lists and free text entry and includes information such as the calendar event time, date, meeting room, attendance list, meeting agenda, and other relevant descriptions.

The sharing of a digitally-based modifiable calendar is also known and they often have a general feature that consists of granting viewing rights to selected calendar community members so that they may inspect the owner's calendar entry at their will. In some instances, such calendars can also grant third parties such as administrative assistants the ability to modify calendar data.

This approach does not provide any computational assistance at the strategy or reasoning level and places a significant burden on the user to maintain their goals relative to their calendar. At present, the user must provide all guidance in determining the value of any individual calendar entry relative to their management, optimization, or goal strategy. For example, if the user wishes to balance their time allocation between different events, the balancing must be initiated by them at the time of their initial data entry and, it must be maintained directly by them as new invitations are received from others. Also, if the user wishes to find opportunities for meetings, no automated methods are available to assist the user in finding points of common interest and connection. For example, if the user wants to build a stronger relationship with a person based on common interests such common interests are not readily identifiable by any party even though both calendars may contain data indicating common interests. At present, the common interest information is discovered manually and neither party is notified of their common interest.

### SUMMARY

Embodiments in accordance with the present invention can provide a method and system for facilitating goal based intelligent calendaring using policies and data analysis. Other embodiments can also automate the discovery and notification process for common interests among calendar users. For example, such capability can be used for sports fans, college alumni, or hobbyists to identify members of the same interest group and suggest convenient times for them to meet.

In a first embodiment of the present invention, a method of facilitating goal based calendar management can include the steps of creating a calendar item from a user entry and an external entry, determining if the calendar item is a policy related item, extracting policy attributes for the calendar item, determining if an action is required based on the policy attributes, the user entry, and the external entry, and executing the action based on the policy attributes when the action is determined to be required. The method can further include presenting a suggested action based on the policy attributes and accepting an entry corresponding to the suggested action. The method can further include presenting a modification of the external entry based on the policy attributes and accepting an entry corresponding to the modification of the external entry. The method can also include presenting an action related to a common context as a result of an analysis of the policy attributes. Note, the external entry can be contextual information associated with calendar information from the external entry.

In a second embodiment of the present invention, a calendaring device can include a presentation device such as a display and a processor coupled to the presentation device. The calendaring device can be a cellular phone, a smart phone, a two-way paging device, a laptop computer, or a personal digital assistant for example. The processor can be programmed to create a calendar item from a user entry and an external entry, determine if the calendar item is a policy related item, extract policy attributes for the calendar item, determine if an action is required based on the policy attributes, the user entry, and the external entry, and execute the action based on the policy attributes when the action is determined to be required. The processor can be further programmed to present a suggested action based on the policy attributes and to accept an entry corresponding to the suggested action. The processor can be programmed to present a modification of the external entry based on the policy attributes and to accept an entry corresponding to the modification of the external entry. The processor can be programmed to present an action related to a common context suggested as a result of an analysis of the policy attributes. The external entry can be contextual information associated with calendar information from the external entry. The external entry can also include data about who, when, where, what, or a context as mentioned above. Also note that the policy attributes can include weighted or prioritized attributes among activity type, location type, meeting type, content type, and person type.

In a third embodiment of the present invention, a calendaring system can include a sending device for sending a calendar entry and a recipient device for receiving the calendar entry. The system can further include a processor operatively coupled to the recipient device and the sending device. The processor can be programmed to create a calendar item from a user entry and the calendar entry, determine if the calendar item is a policy related item, extract policy attributes for the calendar item, determine if an action is required based on the policy attributes, the user entry, and the external entry and execute the action based on the policy attributes when the action is determined to be required. The processor can also be further programmed to present a suggested action based on the policy attributes.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. The “processor” as described herein can be any suitable component or combination of components, including any suitable hardware or software, that are capable of executing the processes described in relation to the inventive arrangements.

Other embodiments, when configured in accordance with the inventive arrangements disclosed herein, can include a system for performing as well as a machine readable storage for causing a machine to perform the various processes and methods disclosed herein.

### BRIEF DESCRIPTION OF THE DRAWINGS

FIG. 1 is a flow diagram as configured in accordance with an embodiment of the present invention.

FIG. 2 is a list of policy attributes that may be used in accordance with an embodiment of the present invention.

FIG. 3 is a flow diagram showing the details of a calendar entry with typical meeting data and an additional entry for personal activity data that is recommended for acceptance by the recipient's system in accordance with an embodiment of the present invention.

FIG. 4 is a flow diagram showing the details of a calendar entry with typical meeting data and an additional entry for personal activity data that is recommended for modification by the recipient's system.

FIG. 5 is a table of weighted or prioritized policy attributes in accordance with and embodiment of the present invention.

FIG. 6 is a block diagram of a communication device or communication devices within a system in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments herein can be implemented in a wide variety of exemplary ways in various devices such as in digitally modifiable calendars in personal digital assistants, cellular phones, laptop computers, desktop computers and the like. Generally speaking, pursuant to these various embodiments, a digital processing platform can include a modifiable calendar utilizing user created source materials that are created and managed by the user. The user's input and other calendar input from other users can be intercepted and managed against or analyzed in view of policy attributes set in the digitally modifiable calendar. These policy attributes can consist of several items including time provisions, names of people, and locations and the calendar item entered can be managed depending on their acceptability against these policy attributes including acceptance, rejection, or proposed action.

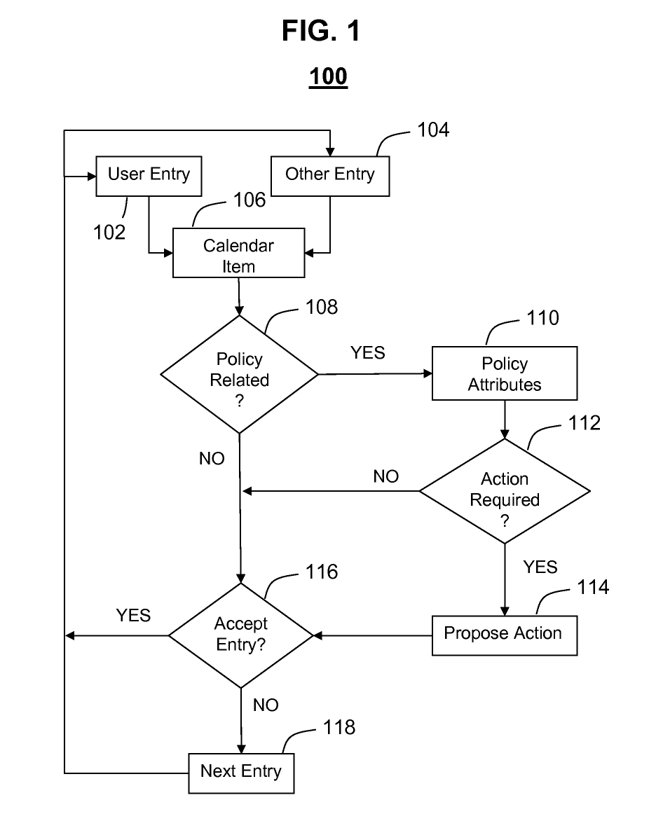

Referring to FIG. 1, a method 100 or decision logic related to a system of data entry policy checking in accordance with an embodiment herein is shown. The method 100 can include the entry of a user entry 102 and an other entry 104 such as one from a co-worker or family member or any other third party into a calendar item 106. A determination of whether the calendar item 106 is policy related is made at decision block 108. If the calendar item is not policy related at decision block 108, a determination is made whether to accept the entry at decision block 116. If the entry is accepted at decision block 116, then the method returns. If the entry is not accepted, then the next entry 118 is looked at before the method returns. If the calendar item 106 is determined to be policy related at decision block 108, then the calendar item 106 (including the user entry 102 and other entry 104) is analyzed in view of policy attributes 110. At decision block 112, a determination is made whether an action is required. If no action is required, a determination whether to accept the entry at decision block 116 is made as previously explained. If an action is required at decision block 112, then the action is proposed at step 114 and once again a determination is made whether to accept the entry at decision block 116.

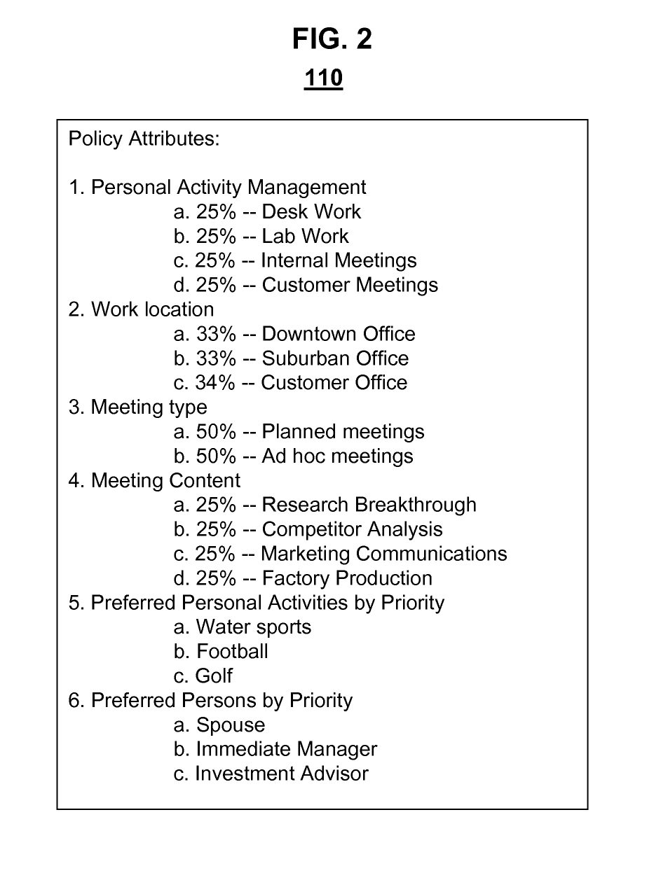

Referring once again to FIG. 1, the method 100 can create a calendar item from a user entry and an other entry. The user entry can be for example a meeting date, a proposed meeting date, an acceptance, a refusal and optionally other data associated with a calendar item such as invitees, date, time, location, and conditions. Likewise, the other entry can be from a third party and can include a meeting date, a proposed meeting date, an acceptance, a refusal and optionally other data associated with a calendar item such as invitees, date, time, location, and conditions. At step 108, a determination can be made whether the calendar item is a policy related item for example by comparing the data in the calendar item with data in a database or lookup table that contains policy attributes 110. The policy attributes can be extracted from the database or lookup table by comparing the calendar item and using associated rankings, weightings or percentages that match or substantially match the data in the calendar item. Further details of such extraction become apparent in the explanation of the policy attributes 110 with respect to FIGS. 2-4. The method 100 further determines if an action is required at step 112 based on the policy attributes, the user entry, and the external or other entry. In other words, based on the policy attributes and the calendar entry, the method 100 can propose an action at step 114 and perform or execute such action when the action is determined to be required. Note, although the user entry and other entry form the calendar item, it is contemplated within the scope of the claims that a calendar item can include just a user entry or just the other entry where such entries are entered as a default or in an automated fashion when a party is non-responsive or under other certain conditions as might be set by the user, a third party, or a service provider for example.

Referring to FIG. 2, an example of policy attributes 110 is shown in further detail. Policy attributes can be of many categories but generally include place, time, content, and attendance related attributes such as personal activity management, work location, meeting type, meeting content and meeting attendees. The policy attributes 110 include a simple list of such possible attributes and illustrates both activities by percentage weighting, activities by ranked preference, and people by ranked preference. The attributes, weightings, and preferences can be set by the user or one or several defaults can be set by the manufacturer that might fit within a user's idea of desired policy attributes. The actions taken as a consequence of comparing the data entry item and the policy attributes list 110 can be of several types but generally include recommending modifications to the calendar item entered as to the time, place, content, and attendance list to a meeting, rejection of the calendar item, or acceptance of the calendar item.

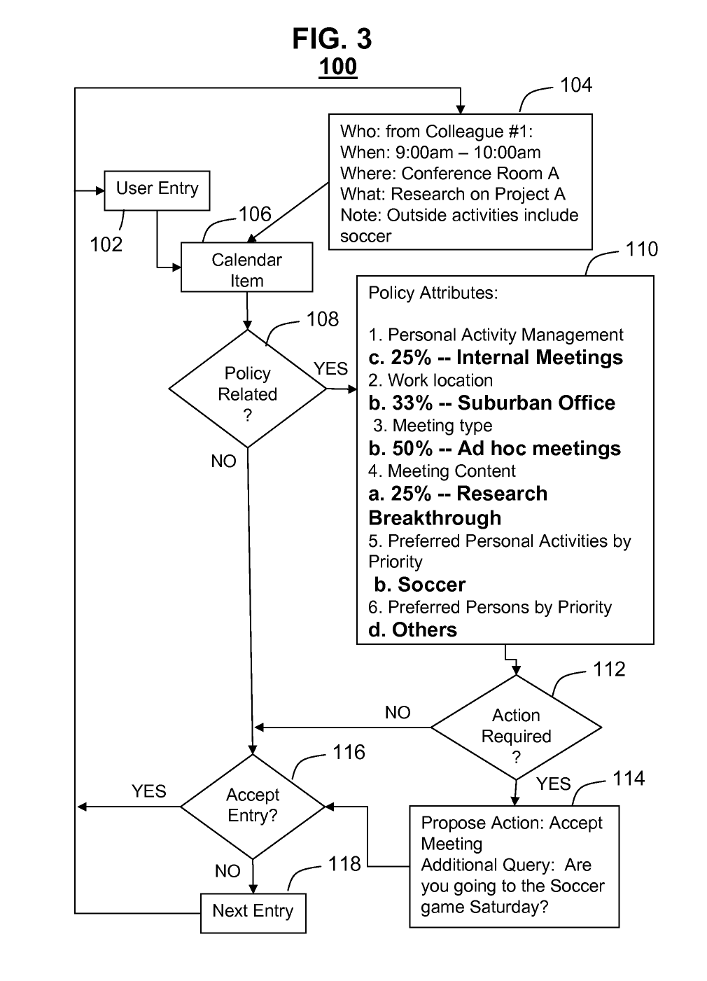

Referring to FIG. 3, the method 100 or decision logic is shown once again with further detail with respect to the other entry 104, policy attributes 110, and proposed action 114. In particular, FIG. 3 illustrates a typical meeting request data set and describes the decision logic and the proposed actions associated with an accepted meeting while leveraging extra information or context information such as personal activity preferences. The policy attributes that are examined or analyzed and confirmed are shown in bold font. In this example, details of a calendar entry with typical meeting data is recommended for acceptance at step 114. Furthermore, a match in context information (e.g., soccer as a personal activity) can trigger an additional entry or query for personal activity data.

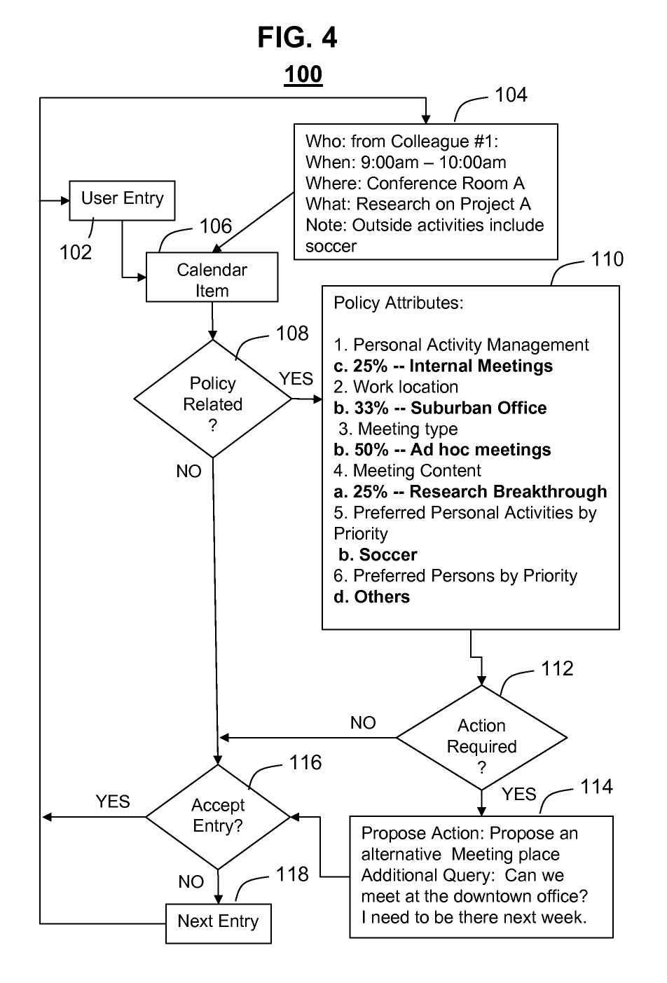

Referring to FIG. 4, the method 100 or decision logic is shown once again with further detail with respect to the other entry 104, policy attributes 110, and proposed action 114. In particular, FIG. 4 illustrates the example where the same typical meeting request is rejected because it did not conform to the time usage guidelines defined in the policy attributes list. In this example, the proposed action 114 can include a proposal for an alternative meeting place and can include an additional query about meeting at the alternative meeting place.

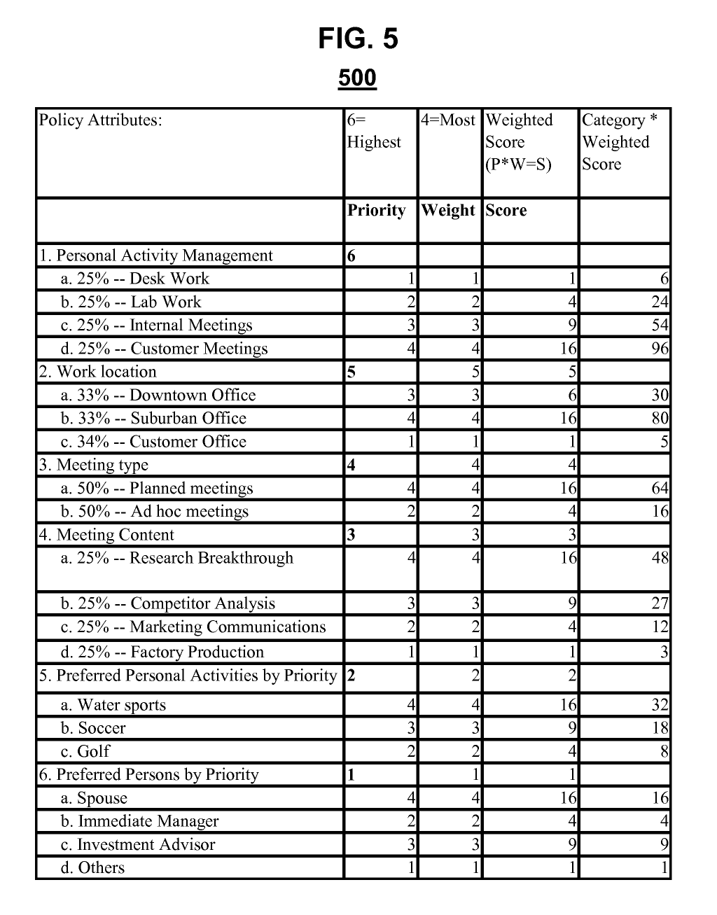

In the event that a user's calendar becomes fully booked, the method of determining the relative priority of a calendar entry request will be based on a scoring mechanism where each category will be assigned a weighted score based on preferences indicated by the user and each attribute within a category can be assigned a weighted score based on preferences assigned by the user. As shown in FIG. 5, this information could be collected by using a table 500 presented to the user or by a series of questions to the user presented as a graphical or audio dialogue. Once this table 500 of policy attributes is constructed it becomes very clear as shown in this example that a request for a customer meeting (with a weighted score of 96) would take clear precedence over other meetings and that calendar adjustments to create the appropriate open time slot can be implemented in an orderly fashion according to the weighted scores. Of course, the table 500 is not limited to such arrangement and more sophisticated tables can be constructed that accommodates or accounts for days of the week weights or time of day weights as well, so that week-end weighting or nighttime weights, for example, can be substantially different than week day (i.e. work day) weightings or day time (e.g., normal business hours) weightings.

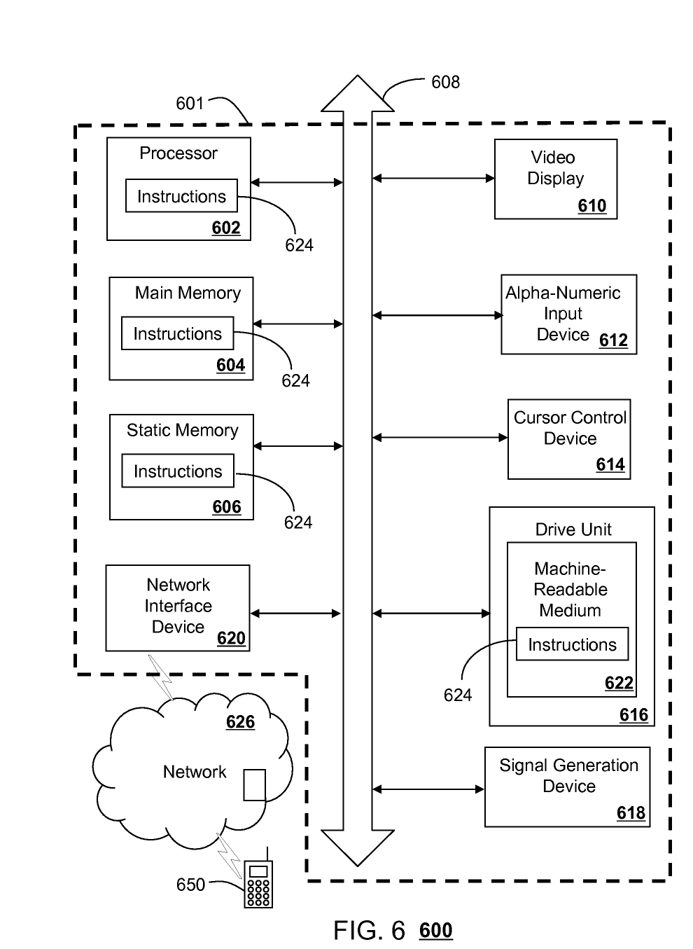

FIG. 6 depicts an exemplary diagrammatic representation of a machine in the form of a computer system 600 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. For example, the computer system can include a recipient device 601 and a sending device 650 or vice-versa.

The machine may comprise a server computer, a client user computer, a personal computer (PC), a tablet PC, personal digital assistant, a cellular phone, a laptop computer, a desktop computer, a control system, a network router, switch or bridge, or any machine capable of executing a set of instructions (sequential or otherwise) that specify actions to be taken by that machine, not to mention a mobile server. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 600 can include a controller or processor 602 (e.g., a central processing unit (CPU), a graphics processing unit (GPU, or both), a main memory 604 and a static memory 606, which communicate with each other via a bus 608. The computer system 600 may further include a presentation device such as a video display unit 610 (e.g., a liquid crystal display (LCD), a flat panel, a solid state display, or a cathode ray tube (CRT)). The computer system 600 may include an input device 612 (e.g., a keyboard), a cursor control device 614 (e.g., a mouse), a disk drive unit 616, a signal generation device 618 (e.g., a speaker or remote control that can also serve as a presentation device) and a network interface device 620. Of course, in the embodiments disclosed, many of these items are optional.

The disk drive unit 616 may include a machine-readable medium 622 on which is stored one or more sets of instructions (e.g., software 624) embodying any one or more of the methodologies or functions described herein, including those methods illustrated above. The instructions 624 may also reside, completely or at least partially, within the main memory 604, the static memory 606, and/or within the processor 602 during execution thereof by the computer system 600. The main memory 604 and the processor 602 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of facilitating goal based calendar management, comprising the steps of:
creating a calendar item from a user entry and an other entry;
determining if the calendar item is a policy related item;
extracting policy attributes for the calendar item;
determining if an action is required based on the policy attributes, the user entry, and the external entry; and
executing the action based on the policy attributes when the action is determined to be required.

2. The method of claim 1, wherein the method further comprises the step of presenting a suggested action based on the policy attributes.

3. The method of claim 2, wherein the method further comprises the step of accepting an entry corresponding to the suggested action.

4. The method of claim 1, wherein the method further comprises the step of presenting a modification of the external entry based on the policy attributes.

5. The method of claim 4, wherein the method further comprises the step of accepting an entry corresponding to the modification of the external entry.

6. The method of claim 1, wherein the method further comprises the step of presenting an action related to a common context as a result of an analysis of the policy attributes.

7. The method of claim 1, wherein the external entry comprises contextual information associated with calendar information from the external entry.

8. A calendaring device, comprising:
a presentation device; and
a processor coupled to the presentation device, wherein the processor is programmed to:
create a calendar item from a user entry and an external entry;
determine if the calendar item is a policy related item;
extract policy attributes for the calendar item;
determine if an action is required based on the policy attributes, the user entry, and the external entry; and
execute the action based on the policy attributes when the action is determined to be required.

9. The calendaring device of claim 8, wherein the processor is further programmed to present a suggested action based on the policy attributes.

10. The calendaring device of claim 9, wherein the processor is further programmed to accept an entry corresponding to the suggested action.

11. The calendaring device of claim 8, wherein the processor is further programmed to present a modification of the external entry based on the policy attributes.

12. The calendaring device of claim 11, wherein the processor is further programmed to accept an entry corresponding to the modification of the external entry.

13. The calendaring device of claim 8, wherein the processor is further programmed to present an action related to a common context suggested as a result of an analysis of the policy attributes.

14. The calendaring device of claim 8, wherein the external entry comprises contextual information associated with calendar information from the external entry.

15. The calendaring device of claim 8, wherein the calendaring device comprises a cellular phone, a smart phone, a two-way paging device, a laptop computer, or a personal digital assistant.

16. The calendaring device of claim 8, wherein the presentation device comprises a display.

17. The calendaring device of claim 8, wherein the policy attributes comprises weighted or prioritized attributes among activity type, location type, meeting type, content type, and person type.

18. The calendaring device of claim 8, wherein the external entry comprises data about who, when, where, what, or a context.

19. A calendaring system, comprising:
a sending device for sending a calendar entry; and
a recipient device for receiving the calendar entry;
a processor operatively coupled to the recipient device and the sending device, wherein the processor is programmed to:
create a calendar item from a user entry and the calendar entry;
determine if the calendar item is a policy related item;
extract policy attributes for the calendar item;
determine if an action is required based on the policy attributes, the user entry, and the external entry; and
execute the action based on the policy attributes when the action is determined to be required.

20. The calendaring system of claim 19, wherein the processor is further programmed to present a suggested action based on the policy attributes.
